(19) United States
(12) Patent Application Publication
(10) Pub. No.: US 2005/0267794 A1
(43) Pub. Date: Dec. 1, 2005

(54) Temporary employment system and method

(75) Inventor: Gaetano J. Forte, Bainbridge Island, WA (US)

Correspondence Address: DAVIS WRIGHT TREMAINE, LLP, 2600 CENTURY SQUARE, 1501 FOURTH AVENUE, SEATTLE, WA, 98101-1688, US

(73) Assignee: The Rx Guy, Inc., Bainbridge Island, WA (US)

(21) Appl. No.: 10/973,956

(22) Filed: Oct. 25, 2004

Related U.S. Application Data
(60) Provisional application No. 60/575,215, filed on May 27, 2004.

(51) Int. Cl. G06F 17/60

(52) U.S. Cl. 705/9

(57) ABSTRACT

A temporary employment system and method allows for coordination of agreement between potential employers and potential employees for temporary employment assignments through use of networked computer systems such as those found involving the Internet. Reduced manpower requirements for coordination efforts and other factors provide potential for increased hiring efficiencies and subsequent reduced operational costs.

### BACKGROUND OF THE INVENTION

1. Field of the Invention

The present invention is directed generally to computer systems and, more particularly, to computer systems for market transactions.

2. Description of the Related Art

Inefficiencies exist in coordinating agreement between potential employers (also referred to herein as ERs) and potential employees (also referred to herein as EEs) for temporary staffing of credential based assignments. Conventional approaches include temporary agencies, which provide a screening function for potential employers and an interface function for potential employees. Unfortunately, inefficiencies still exist, which can, among other things, adversely impact operational costs for the employers and can reduce contact opportunities for the temporary employees.

### BRIEF DESCRIPTION OF THE SEVERAL VIEWS OF THE DRAWING(S)

FIG. 1 is a schematic depicting a temporary employment system.

FIG. 2 is a flowchart depicting a method for coordination of temporary employment.

FIG. 3A is a screen shot of a generically represented employer login.

FIG. 3B is a screen shot of employer login involving pharmacists as potential employees.

FIG. 4A is a screen shot of a generically represented employer registration page.

FIG. 4B is a screen shot of employer registration page involving pharmacists as potential employees.

FIG. 5A is a screen shot of a generically represented employer main page.

FIG. 5B is a screen shot of an employer main page involving pharmacists as potential employees.

FIG. 6-1 through 6-4 is a table of employee types and associated credentials.

FIG. 6A is a screen shot of a page for modifying the table of employee types and associated credentials of FIG. 6.

FIG. 7A is a screen shot of a generically represented employee login.

FIG. 7B is a screen shot of an employee login involving pharmacists as potential employees.

FIG. 8A is a screen shot of a generically represented employee registration page.

FIG. 8B is a screen shot of an employee registration page involving pharmacists as potential employees.

FIG. 8C is a screen shot of an alternative employee registration page.

FIG. 9A is a screen shot of a generically represented employee main page.

FIG. 9B is a screen shot of an employee main page involving pharmacists as potential employees.

FIG. 10 is a flowchart of a method to initially implement an employer based certification requirement.

FIG. 11 is a flowchart of a method involving employer based certification and registration of a new potential employee.

FIG. 12 is a screenshot of a generically represented employer main page having an employer based certification selection option.

FIG. 13 is a screenshot of a certification page to be used by employers to certify or decertify potential employees.

FIG. 14 is a screenshot of a certification initiation page having an employee type area.

### DETAILED DESCRIPTION OF THE INVENTION

As will be discussed in greater detail herein, a temporary employment system and method allows for coordination of agreement between potential employers and potential employees for temporary employment assignments through use of networked computer systems such as those found involving the Internet. Reduced manpower requirements for coordination efforts and other factors provide potential for increased hiring efficiencies and subsequent reduced operational costs.

The temporary employment system and method involves the subject of contracts, which includes at least some of the following concepts. Bargaining generally culminates in a contract when both parties assent to be bound and the associated terms used in the bargaining are definite enough to be enforceable. Assent can be stated by the parties to a contract either in writing or may other means and through the doctrine of consideration both parties somehow refer to each other. The party offering a promise to do something generally seeks payment from the party receiving the promise.

Definite terms help a court to determine the confines of a promise and to be able to accurately calculate damages in the event the promise is not honored. Under conventional theory there is an exact time, regardless of the difficulty involved in its determination, when a party's promise becomes a contract and the promisee's expectation interest is protected. If both parties make promises, both parties are viewed as contractually bound in concurrent fashion to avoid speculation.

Offer and acceptance are the two steps involved in contract formation. Accordingly, the offeror conveys to the offeree through the offeror's offer willingness to be contractually bound for a promise and empowers the offeree to form a contract upon acceptance of the offeror's offer thereby making the offeror liable to the offeror's offer.

The offer can be withdrawn any time prior to a contract being formed by the acceptance of the offer. Most contracts are bilateral in that both parties make a promise although some contracts are unilateral, in that only the offeror makes a promise. The traditional premise states that the final contract must contain all the terms necessary for the agreement between the parties but the courts using the second premise have supplied the missing terms to complete the contract. The more terms left out of the agreement may be interpreted as the parties not really intending to enter into a contract at all.

Offers can be communicated in any way, for example offers can be written, spoken, or implied. Any action that would cause a reasonable man to deduce a promise has been made in exchange for a payment can be considered a valid offer. An offer is not considered valid until it reaches the offeree. An offer can be withdrawn before it reaches the offeree.

Offers are not really offers but merely proposals when they don't give the offeree the ability to accept the offer and form a contract, or fail to limit quantities that would exceed the offeror's capability. An auctioneer does not make offers, but does receive offers in the form of bids.

The offeror is consider to be the master of the offer and is solely responsible for choosing who the offer is directed to. The offer can be directed to one or many offerees. An offer can only be accepted by an offeree, the person it has been offered to. The offeror may limit the expiration period of the offer.

The acceptance is the action taken by the offeree that results in a contract between the offeror and the offeree. and is on the terms contained in the offer. Under the objective theory, as long as the action taken by the offeree causes the offeror to believe an acceptance has been made, a valid contract is formed by the parties.

There are three basic requirements for an acceptance to considered valid. First, the person indicating acceptance must give an expression of commitment, second, cannot be conditional on any other acts by the parties, and third, the terms cannot be altered. The power of the offeree to accept can be cancelled by the withdrawal of the offer before acceptance, the death or incapacity of the offeror, the time period of the offer running out, or the rejection of the offer by the offeree.

As described further below, the temporary employment system and method allows a potential employee (also referred to herein as a “potential EE”) to make an offer by entering a time-place-wage (time being in some form a range of time such as including particular days and/or available, place being a general geographical area as described in various ways, wage being a range, exact amount, or a minimum level, or otherwise stipulated) commitment into a database of the temporary employment system along with the potential EE's associated qualifications including one or more employee types and associated credentials. An employee type is a skill designation for particular temporary assignments such as pharmacist, audiologist, optician, etc.

The potential EE's entry of a time-place-wage commitment and associated qualifications into the temporary employment system becomes an offer once one or more potential employers (also referred herein as “potential ERs”) have submitted a temporary assignment request to the temporary employment system. The temporary assignment request includes the relevant employee type for the assignment, wage information such as acceptable wage range, or maximum wage permitted, assignment location and duty hours.

Once a temporary assignment request of a potential ERs is entered into the temporary employment system, a search engine searches for any relevant entries made by potential EEs. One or more matches can occur including a match with the present potential EE's entry given that the potential ER's temporary assignment request and the pontetial EE's entry have common employee types, the potential EE's other qualifications meet the minimum requirements of the potential ER's temporary assignment request, and time-place-wage particulars of the potential ER's temporary assignment request match the time-place-wage commitment of the potential EE's entry.

The potential EE's entry gives the one or more potential ERs with matching temporary assignment requests the power to accept the potential EE's entry by giving the first of the one or more potential ER's to accept the capability of reporting acceptance to the potential EE as a binding employment contract between the first accepting potential ER and the potential EE thereby requiring the potential EE to report for a temporary assignment as the temporary EE of the first accepting potential ER as the accepting ER. Reporting of acceptance establishes a binding employment contract between the potential EE as the temporary EE and the first accepting potential ER as the accepting ER for reasons including that there is sufficient definiteness of contractual terms as described by the potential EE's entry, which the potential ER is able to review before accepting and the report of acceptance send by the first accepting one of the matching potential ERs, which includes such terms as the wage, assignment location, and duty hours.

Since the potential EE acknowledges a commitment to work in a general location (which includes the actually assignment location as arrived through the matching process as reported by the acceptance report) for a particular wage or wage range (which includes the actual wage as arrived through the matching process as reported by the acceptance report) for a certain number of hours or range of hours at particular ranges of days and/or hours (which includes the actual days and hours to be worked as arrived through matching process and reported by the acceptance report) there are sufficient definite terms for the employment contract that no further negotation need to be done subsequent to the matching and first accepting potential employer sending the report of acceptance through the temporary employment system as the accepting employer to the potential employee as the temporary employee.

Prior to posting any potential EE entries or any temporary assignment requests by the potential ERs, all participating potential EEs and potential ERs are instructed regarding operation of the temporary employment system including the information presented above to help minimize any confusion and to insure that both a potential EE submitting an entry and a matching and first accepting potential ER understand that by sending a report of acceptance to the potential EE the matching and first accepting potential ER has formed a binding employment contract between the potential EE and the potential ER. This additional effort to instruct participating potential EEs and potential ERs regarding the contractual nature of the temporary employment system will provide sufficient information so that reasonable potential EEs and reasonable potential ERs will understand and believe that a binding contract has been formed when the report of acceptance from the matching and first accepting potential ER has been received by the potential EE.

Further clarification in the procedures could be offered. For instance, the participating potential EEs and potential ERs could be instructed that a binding employment contract exists once the report of acceptance is received by a designated communication device associated with a particular potential EE rather than requiring that the potential EE first read the report of acceptance before a binding employment contract is formed. Other implementations may stipulate that the potential EE has to read the acceptance report for a binding contract to be formed or that the potenial EE received the acceptance report in another manner. It may be further stipulated that the designated communication device need to remain accessible and report its accessibility status into the temporary employment system on a frequent basis so that the potential ERs can be assured that their reports of acceptance will be properly received.

Other measures could also be put in place to foster better reliability including an acknowledgement of receipt being sent back to a designated communication device of the accepting ER either manually or automatically by the receiving communication device of the accepted EE. Such mechanisms as found in e-mail systems today such as Outlook by Microsoft of Redmond, Wash. allow for various receipts to be sent back to the accepting ER to confirm receipt of the report of acceptance. Some implementations of the temporary employment system may have other methods of communication not using an e-mail system, which may also provide various capabilities for generation and transmission of receipts acknowledging receipt of acceptance reports or receipt of the initial entries by the potential EEs and/or receipt of the temporary employment requests by the potential ERs.

Some implementations involve manual or automated notification of the ER that the EE has received the ER's acceptance. In these implementations, the ER's interests may be further protected with use of a time limit arrangement wherein the ER would be free to accept another EE's offer if the ER did not receive a reply from the EE within a specific time period (such as an hour or a day) as notification that the EE had received the ER's acceptance.

Under these implementations, since the EE's offer allows the ER to form a binding contract, a contract provision could be included to specify that if the ER did not receive a timely reply from the EE that the EE has received notification of the ER's acceptance, the EE would be liable for contract damages to be paid to the ER by the EE for breach of the contract by the EE for failure to reply within an agreed upon time period. These types of implementations having the time limit arrangement allow the ER to accept other offers from other EEs under these described circumstances.

For example, in some implementations, the EE could receive an email informing the EE that one of the EE's offers has been accepted and thereby directing the EE to log into an appropriate web site. On the web site, blinking brightly colored text could be activated on the Employee Main Page that signals the EE that one or more of their offers has been accepted by an ER. The EE is also presented by the web site with a new link identified as “Unconfirmed, that has previously been hidden, directing the EE to a page containing a list of their offers accepted by the ERs that they have not yet communicated notification of the acceptance of the ERs back to the ERs. Each unconfirmed accepted offer has a corresponding button marked “Confirmed” which when pressed, sends notification to the ER that the ER's acceptance of the EE's offer has been received by the EE.

Limited details about the acceptance are presented, which only include specific date and exact start and end time of assignment, specific city of assignment, and employee type of assignment. Also each unconfirmed accepted offer has an entry that shows the time the EE has left to send notification to the ER that the EE has received the acceptance of the ER for the offer of the EE. The pressing of the “Confirmed” button also deletes the entry from the list of unconfirmed accepted offers. Another link on the EE main page is marked “Confirmed”. This “Confirmed” link directs the EE to their list of accepted offers that they have communicated notification to the ER of receiving the acceptance by the ER of that offer. This list contains a very detailed description of the assignment which includes exact rate of pay, specific address, and contact information, of the assignment.

In an implementation, an ER main page could have links labeled “Unconfirmed” and “Confirmed.” The “Unconfirmed” link could direct the ER to a list of offers that has been accepted by them, but they have not yet received back from the EE, a notice of the EE's receiving the acceptance of the offer from the ER. In this implementation, the unconfirmed list could contain specific details about the assignment, which includes the name and address of the assignment, the exact date of the assignment, the exact start and end time of the assignment, and the exact rate of pay of the assignment, but may only contain limited information about the EE. The information provided about the EE, in the unconfirmed list, may only contain employee type, degree, and current employer. This unconfirmed list also could have an entry that shows the time the EE has left to send notification to the ER that the EE has received the acceptance of the ER for the offer of the EE.

The link labeled “Confirmed” may direct the ER to a list of contracts that have their offers accepted by the ER, their ER notification received by the EE, and their EE reply received by the ER. This list may contain very detailed description of the assignment, which may include exact rate of pay, specific address, and contact information, of the assignment and also detailed information about the EE, including name, address, phone, email, license number, employee type, degree, and current employer.

Other implementations could exclusively utilize an internal systems approach in which all communication between potential ERs and potential EEs is done within a system hosted on a server or cluster of servers running the system. The communication could be in the form having an “e-mail” style, but the e-mails would stay within a unified database system or other unified communication system rather than being sent out from one e-mail system over a network such as the Internet to a different e-mail system. Use of the unified communication system would exclusively involve the potential ER logging into the unified communication system to check on offers and to transmit notification of acceptance to an EE and would involve the potential EE logging into the communication system to check and reply to notifications of acceptance from ERs without a need to send e-mails outside of the unified communication system.

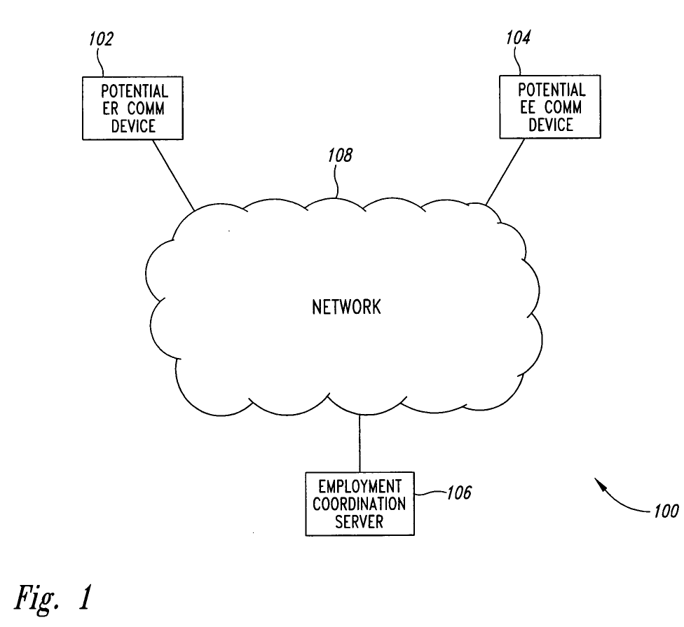

An exemplary temporary employment system 100 illustrated in FIG. 1 includes a potential employer communication device 102, a potential employee communication device 104, and employment coordination server 106, all networked together on a network 108, such as the Internet, a wireless network, or other network. Both the potential employer communication device 102 and the potential employee communication device 104 could be implemented as computer workstations, laptop computers, mobile communication devices, or other communication devices typically able to support browser functions. Other implementations of the potential employer communication device 102 and the potential employee communication device 104 include other communication devices, which also support display of alphanumeric text. The employment coordination server 106 typically can be a networked computer server, but in other implementations could be a plurality of several distributed networked computers or other platforms able to store data and communicate with remote devices over a network.

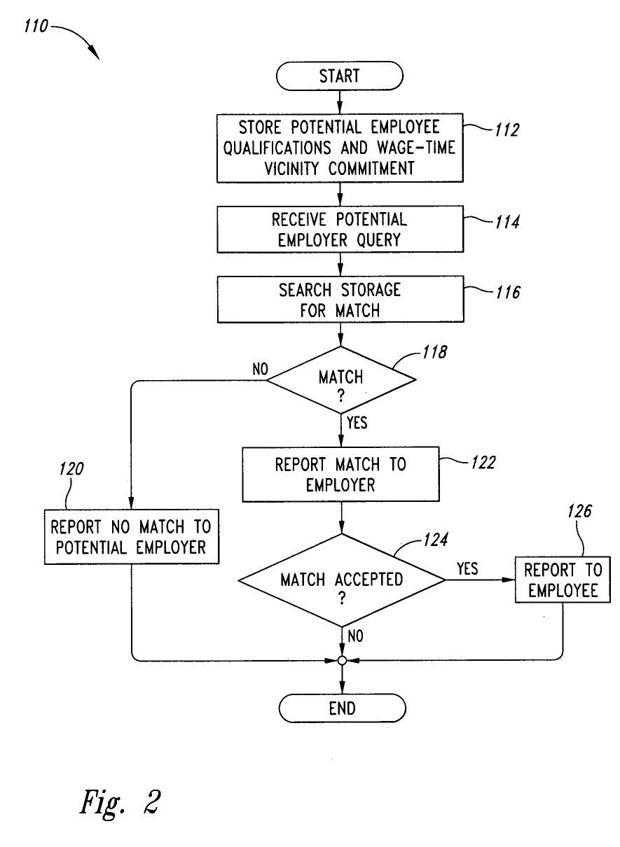

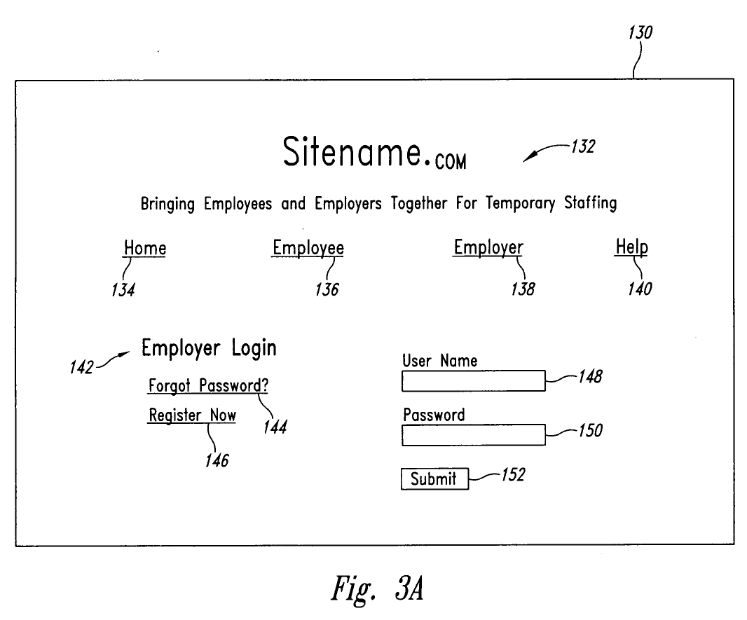

An exemplary method for coordination of temporary employment 110 is illustrated in FIG. 2 where the employment coordination server 106 of the temporary employment system 100 stores potential employee qualifications and one or more wage-time-vicinity commitments (step 112). Typically a potential employee will use the potential employee communication device 104 to interact with the employment coordination server 106 in order to provide the potential employee qualifications and the one or more wage-time-vicinity commitments to the employment coordination server for storage. A potential employer will then use the potential employer communication device 160 to interact with the employment coordination server 106 to submit an employment request, which is received by the employment coordination server (step 114).

The employment request includes requested qualifications and a wage-time-vicinity request indicating time and place of the temporary assignment and an acceptable wage range for associated work. Once the coordination server 106 receives an employment request by a potential employer, the coordination server searches its storage (step 116) to identify any potential employees with requested qualifications that have submitted a wage-time-vicinity commitment matching the potential employer's employment request. In some implementations given the circumstances involved it is possible that steps 114 and 112 may be reversed so that a delay may occur regarding step 116. If a match does not occur (“NO” branch of decision step 118), the employment coordination server 106 sends a report (step 120) over the network 108 to the potential employer communication device 102 that no match has occurred and the method 110 ends. Otherwise (“YES” branch of decision step 118), the employment coordination server 106 sends a report to the potential employer communication device 102 that a match has occurred (step 122) over the network 108. The potential employer then indicates through the potential employer communication device 102 acceptance or rejection of the match. If acceptance of the match is indicated (“YES” branch of decision step 124), a report of the accepted match as a binding employment contract between the potential employer and the potential employee (thereby requiring the potential employee to report for a temporary assignment as a temporary employee) is sent to the potential employee communication device 104 (step 126) and the method 110 ends. Otherwise (“NO” branch of decision step 124), the method 110 ends. Other implementations do not require acceptance of the match found in decision step 124, but rather consider the match itself as an executed contract such that notification is sent to the potential employer communication device 102 and the potential employee communication device 104 of a binding employment contract between the potential employer and the potential employee once a match occurs.

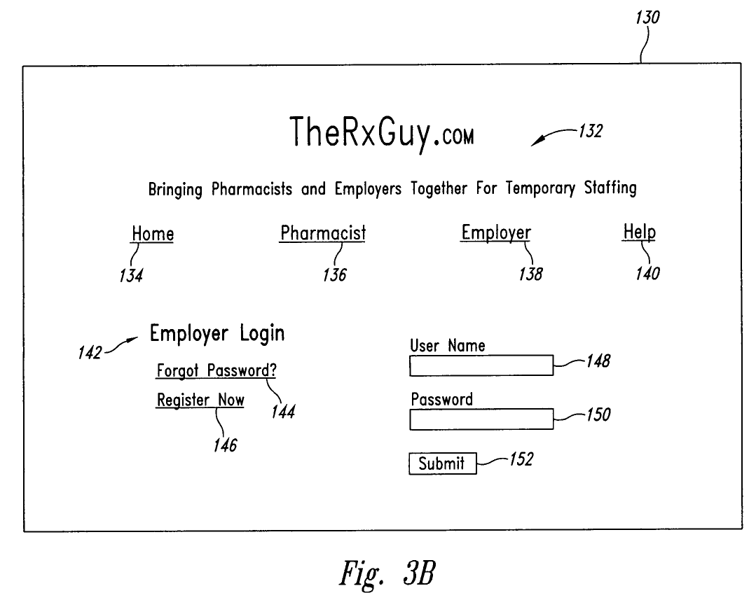

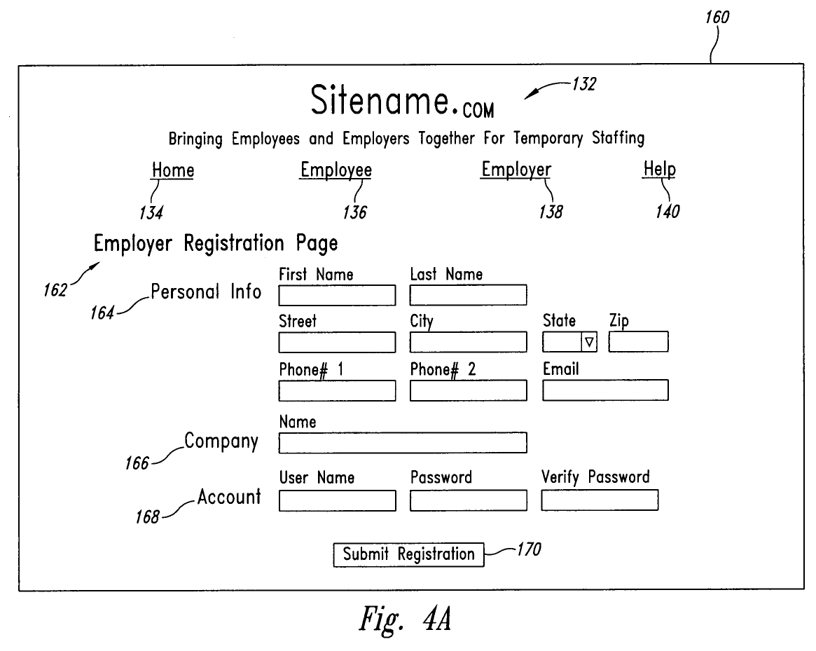

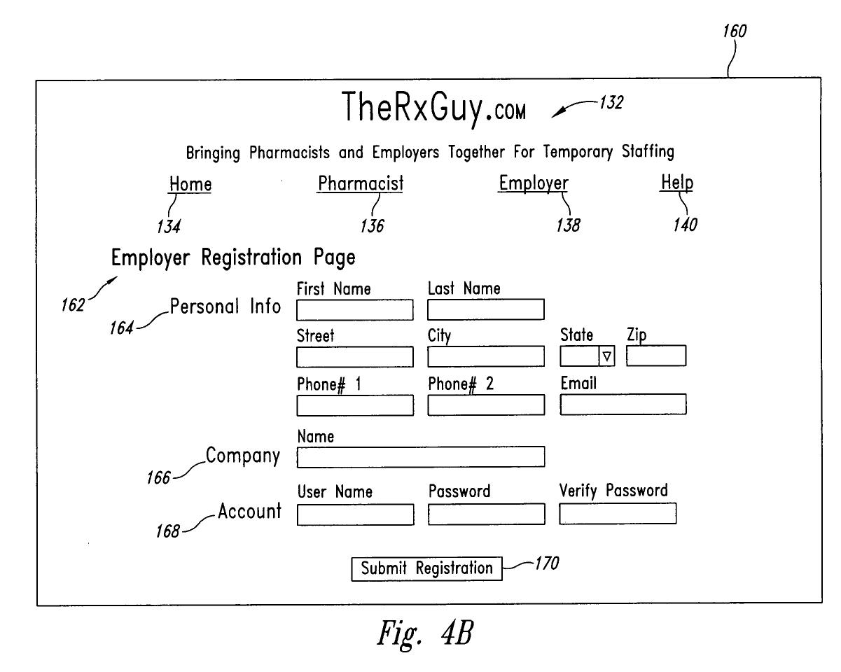

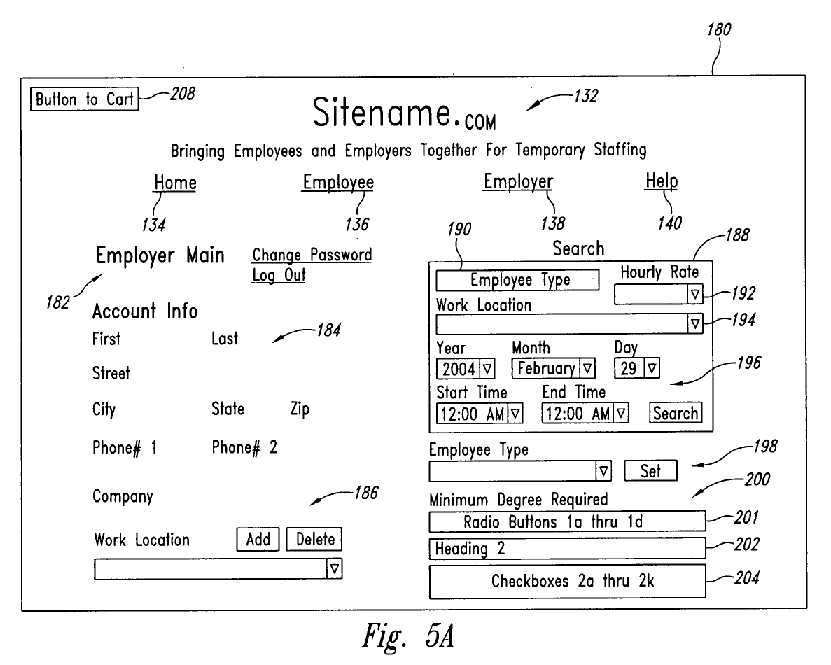

When a potential employer accesses the employment coordination server 106 using the potential employer communication device 102, an employer login screen 130, generically shown in the exemplary illustration of FIG. 3A and shown in FIG. 3B involving pharmacists as potential employees, is sent from the employment coordination server to be displayed by the potential employer communication device. The employer login screen 130 has a website title 132, a home link 134 to access a home page (not shown), an employee link 136 to access an employee login screen (shot in FIGS. 7A and 7B), an employer link 138 to access the employer login screen, and a help link 140 to access a help page (not shown). The employer login screen 130 further includes a web page title 142, a password link 144 used to prompt for assistance in remembering a required password. A registration link 146 is provided to access an employer registration page (shown in FIGS. 4A and 4B) if the potential employer viewing the employer login screen is not already registered with the temporary employment system 100. If the potential employer viewing the employer login screen 130 is already registered with the temporary employment system 100, the potential employer will use a username entry field 148, a password entry field 150, and a submit button 152 for submitting username and password of the potential employer to access the temporary employment system.

When a potential employer is not already registered with the temporary employment system 100, an employer registration page 160, generically shown in the exemplary illustration of FIG. 4A and shown in FIG. 4B involving pharmacists as potential employees, is access by the potential employer through the registration link 146. The employer registration page 160 includes a web page title 162, and personal information entry fields 164 to enter name, physical address, e-mail address, and phone numbers of the potential employer. The employer registration page 160 further includes a company field 166 to enter the company name of the potential employer, account fields 168 to register a username and password for the potential employer, and a submit button to store the entered registration information to the employment coordination server 106.

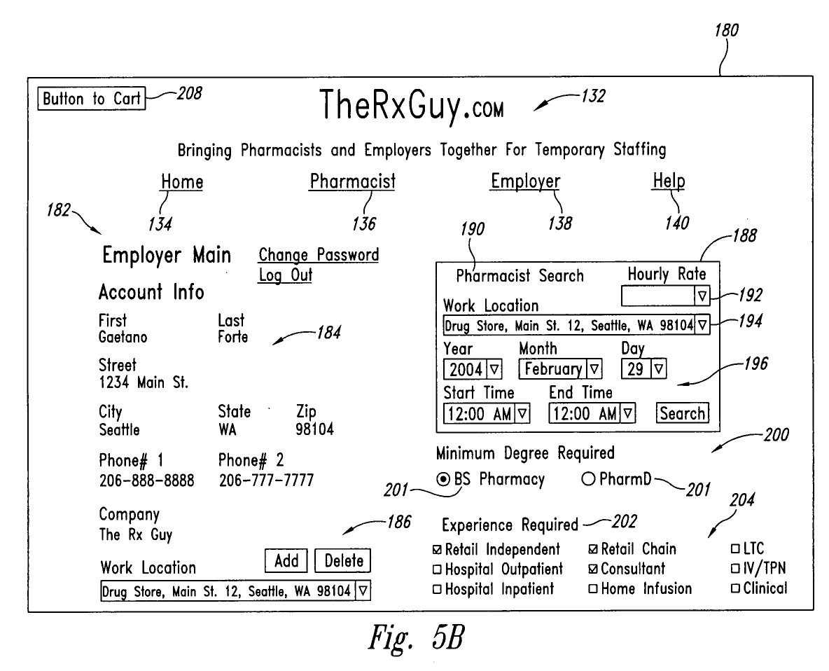

Once a potential employer has submitted a username and password that has been stored in the employment coordination server 106 as being registered, an employer main page 180, generically shown in the exemplary illustration of FIG. 5A and shown in FIG. 5B involving pharmacists as potential employees, is displayed as including a page title 182. The employer main page 180 further includes account information fields 184 that display company information including point of contact name, address, phone numbers, and company name. A work location entry field 186 allows addition and deletion of identified employment locations stored in the employment coordination server 106 as associated with the potential employer identified by the account information fields 184.

The employer main page 180 further includes a search area 188 used by the potential employer to submit a potential temporary employment assignment request. The search area 188 has an employee type display field 190 for identifying employee type desired, an hourly rate entry field 192 for identifying either a range of hourly rates or a maximum hourly rate the potential employer is willing to pay, time fields 196 indicating year, month, day, start time, and end time associated with the temporary assignment request. The search area 188 further has an employee type selection and entry field 198 to set a desired employee type for the temporary assignment request, which is displayed in the employee type display field 190 to indicate current employee type selected. A qualifications area 200 allows the potential employer to select employee qualifications desired for the temporary assignment request.

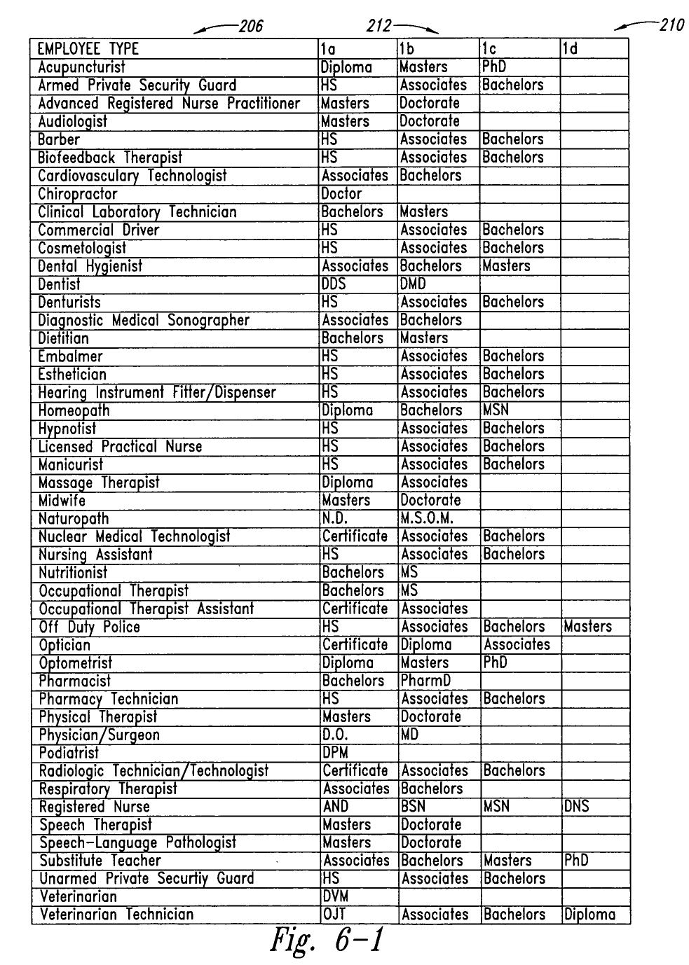

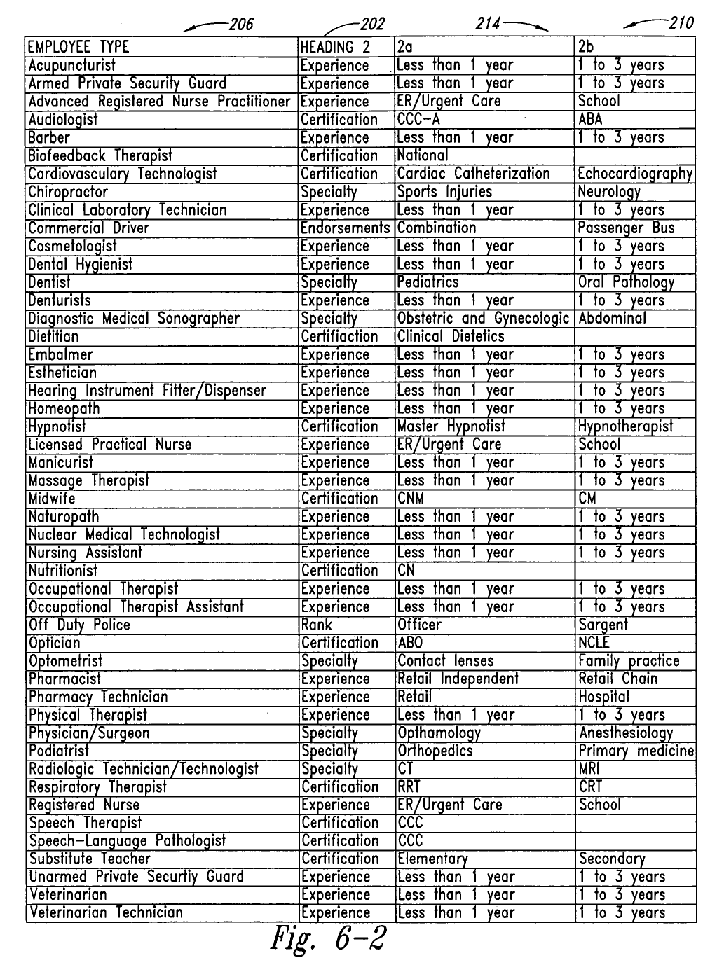

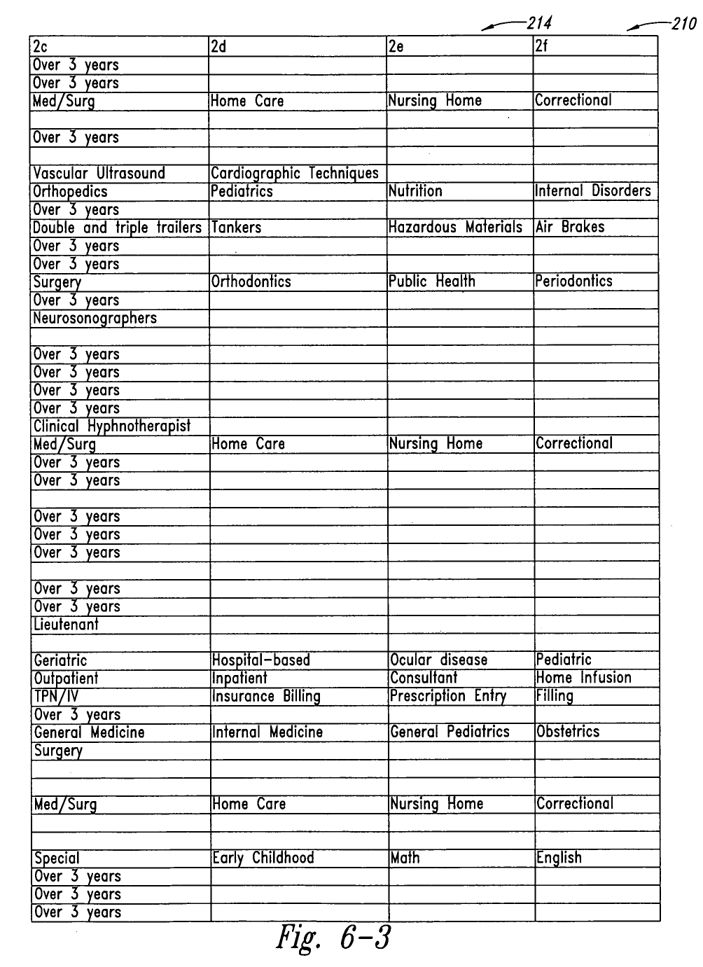

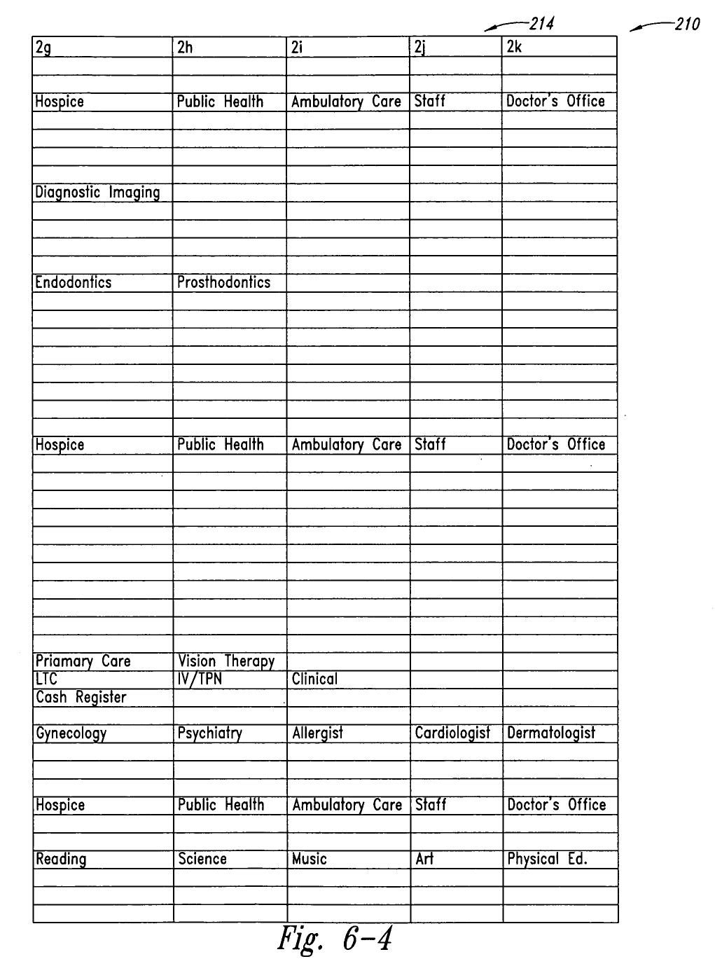

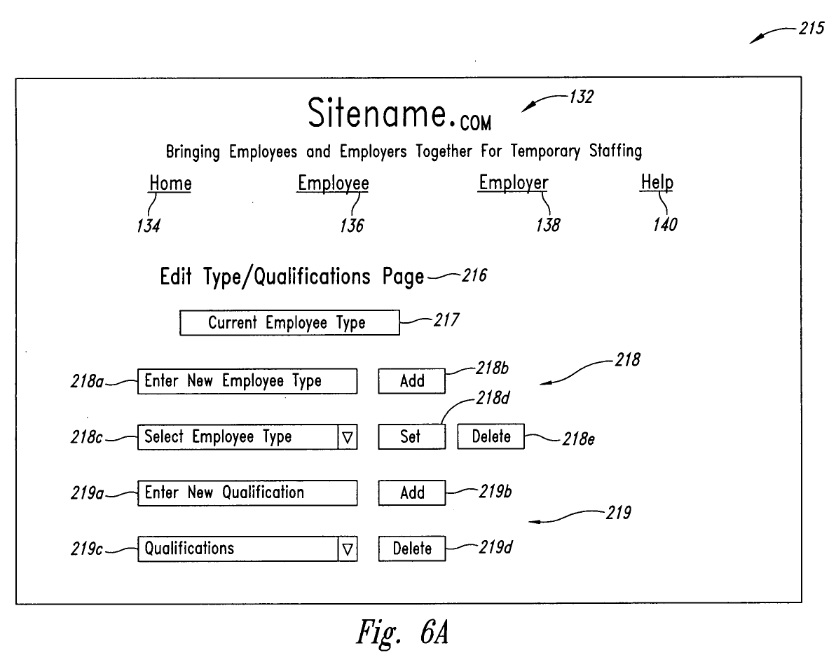

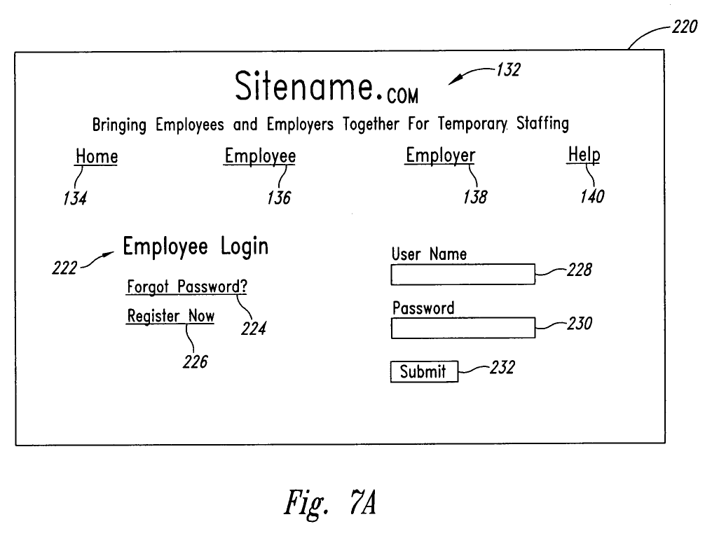

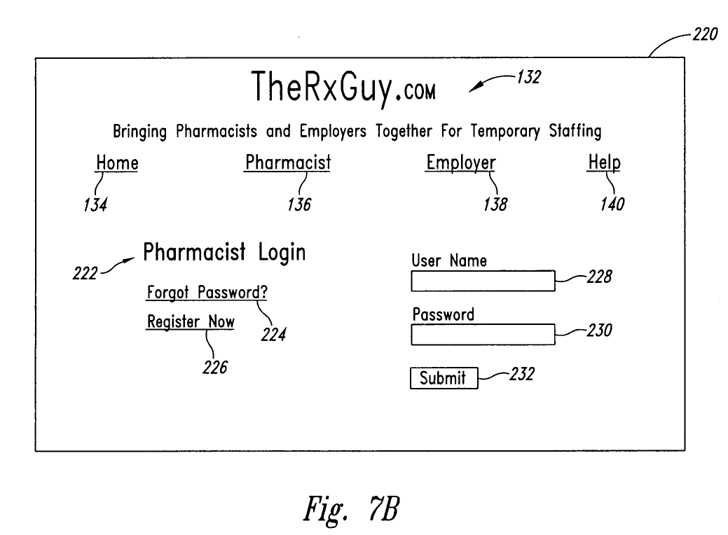

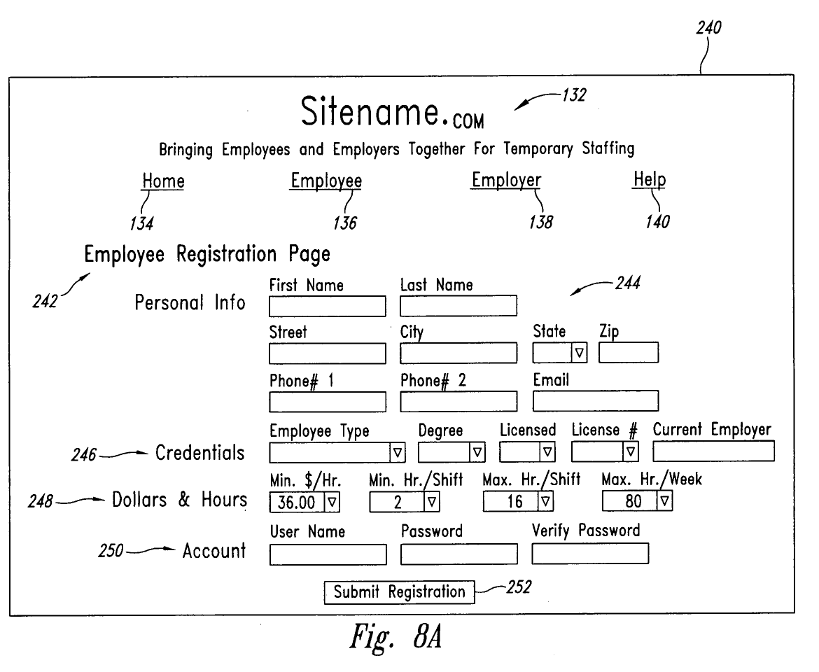

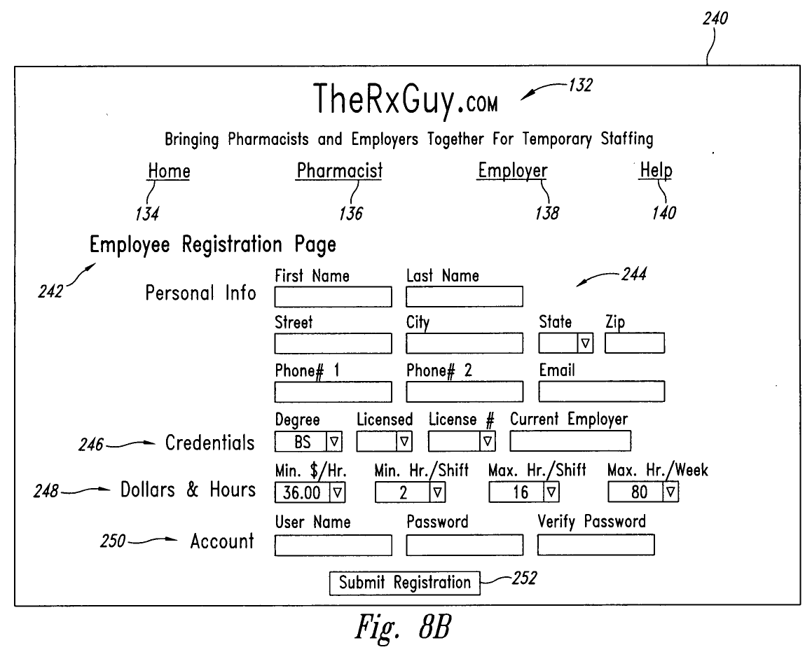

The qualifications area 200 includes an education selection field 201 to provide selection of minimum employee education level required by the potential employer. Further required employee qualifications are indicated by a second qualifications heading 202 and associated second qualifications selection area 204. Exemplary employee types 206 can be stored on the server 106 in the form of a qualifications table 210, as shown in FIG. 6, with associated minimum employee education level selections 212 to be displayed in the education selection field 201 and second qualifications 214 to be displayed in the second qualifications selection area 204. As shown by the second qualifications headings 202 in FIG. 6, the second qualifications 214 differ depending upon on the exemplary employee types 206 and include such examples as amount of experience, type of experience, level of certification, rank, and designated specialty. Other types of second qualifications are also anticipated. Furthermore, other implementations can include selection fields for additional qualifications in the employers main menu, which may permit more than one of the second qualifications 214 to be included in the potential employer's temporary assignment request.

An exemplary edit page 215 to be used by an employer or manager of the server 106 for modifying the qualifications table 210 is shown in FIG. 6A identified by a page title 216. The edit page 215 has a current employee type display 217 to display the employee type of the record in the qualifications table 210 presently subject for modification. The edit page 215 contains an employee type selection area 218 having a new type entry 218a with an add button 218b for adding new employee types to the qualifications table 210. The employee type selection area 218 also has a select employee type entry 218c for selection for modification (using a set button 218d) or deletion (using a delete button 218e) of already existing employee types contained in the qualifications table 210. The edit page 215 also includes a qualifications modification area 219 having a new qualifications entry 219a and an add button 219b for adding qualifications to the qualifications table 210 to be associated with the employee type selected through use of the select employee type entry 218C and the set button 218d. The qualifications modification area 219 also includes an existing qualifications entry 219c and deletion button 219d for deletion of one or more existing qualifications for the qualifications table 210 associated with the employee type selected through use of the select employee type entry 218C and the set button 218d.

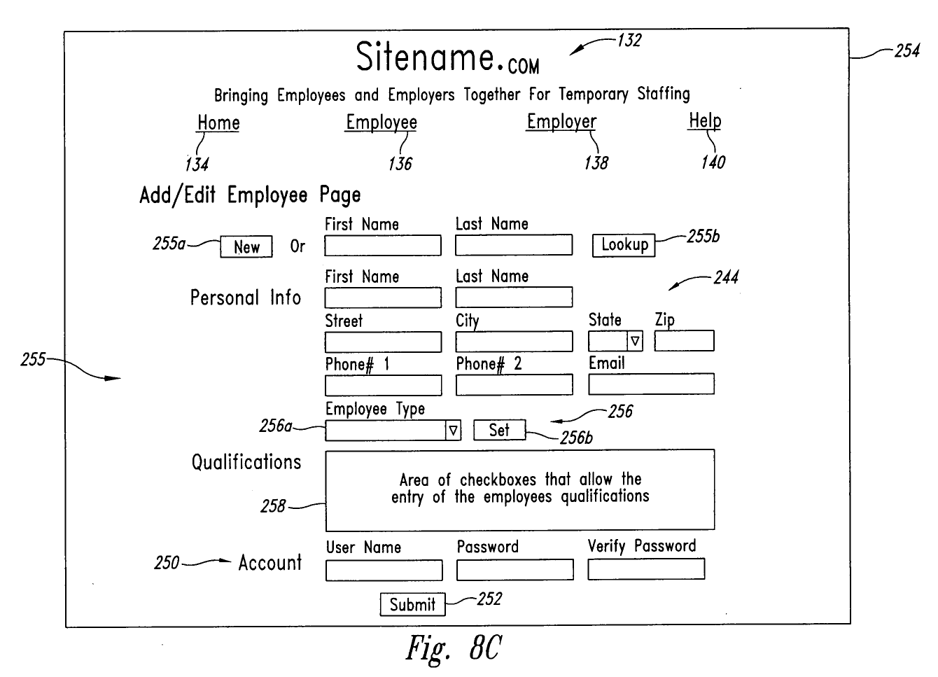

If the employee link 136 is selected, an employee login screen 220, generically shown in the exemplary illustration of FIG. 7A and shown in FIG. 7B involving pharmacists as potential employees, is sent from the employment coordination server 106 to be displayed by the potential employee communication device 104. The employee login screen 220 includes a web page title 222, a password link 224 used to prompt for assistance in remembering a required password. A registration link 226 is provided to access an employee registration page (shown in FIGS. 8A and 8B) if the potential employee viewing the employee login screen is not already registered with the temporary employment system 100. If the potential employee viewing the employee login screen 220 is already registered with the temporary employment system 100, the potential employee will use a username entry field 228, a password entry field 230, and a submit button 232 for submitting username and password of the potential employee to access the temporary employment system.

When a potential employee is not already registered with the temporary employment system 100, an employee registration page 240, generically shown in the exemplary illustration of FIG. 8A and shown in FIG. 8B involving pharmacists as potential employees, is accessed by the potential employee through the registration link 226. The employee registration page 240 includes a web page title 242, and personal information entry fields 244 to enter name, physical address, e-mail address, and phone numbers of the potential employee. The employee registration page 240 further includes a credentials entry field 246 to enter credential information of the potential employee such as employee type, degree(s) earned, type(s) and number of license(s) held, and identification of any current permanent employers. The employee registration page 240 includes dollar-hours fields 248 to indicate the minimum wage that the potential employee is willing to accept and the volume range of hours that the potential employee is willing to work per shift and per week. The employee registration page 240 further includes account fields 250 to register a username and password for the potential employee, and a submit button 252 to store the entered registration information to the employment coordination server 106.

An alternative implementation of an employee registration page 254, shown in FIG. 8C, has an employee identification area 255 to enter employee information of a person not already indicated as an employee (using a new button 255a) or modifying employee information of a person already indicated as being an employee. The employee registration page 254 further includes an employee type area 256 having an employee type entry 256a and a set button 256b to designate a particular employee type to be associated with a qualifications area 258. Once an employee type is chosen through use of the employee type area 256, various qualification entries associated with the chosen employee type can be made in the qualifications area 258 through use of checkboxes or other such entry means know in the art.

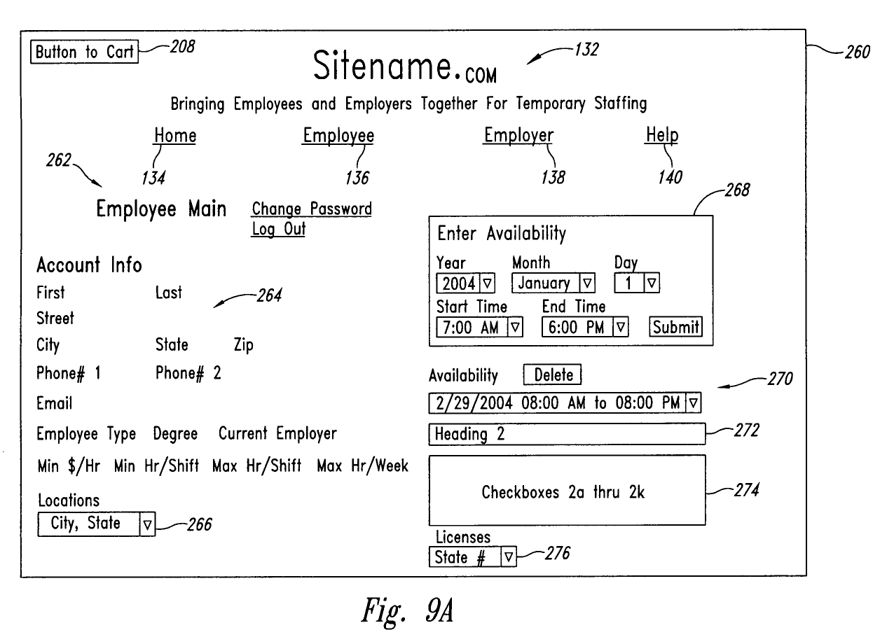

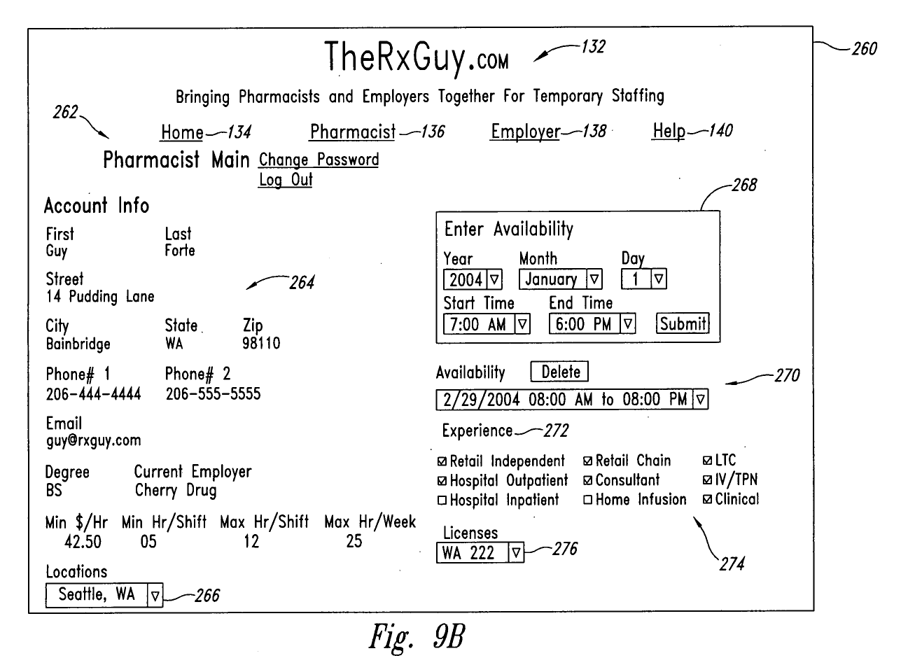

Once a potential employee has submitted a username and password that has been stored in the employment coordination server 106 as being registered, an employee main page 260, generically shown in the exemplary illustration of FIG. 9A and shown in FIG. 9B involving pharmacists as potential employees, is displayed as including a title 262. The employee main page 260 further includes employee information 264 that is currently being stored in the employment coordination server 106 as entered through the credentials entry field 246 and the dollar-hours fields 248 of the employee registration page 240.

A work location entry field 266 allows addition and deletion of identified potential employment locations that the potential employee is willing to work and stored in the employment coordination server 106. An availability entry area 268 includes entry fields for date, start time and end time that the potential employee is willing to commit to work. A submit button of the availability entry area 268 allow the potential employee to submit a formal commitment to the employment coordination server 106 such that if selected by a potential employer through the temporary employment system 100, the potential employee is committed to work on the date-time availability entered through the availability entry area at the location(s) submitted through the location entry field 266 and for a wage and assignment duration compatible with wage and hours information entered in the dollar-hours fields 248 of the employee registration page 240. The formal commitment may involve some sort of positive reward or negative punishment tied with such things as monetary gain or loss, or likelihood of future assignments.

In some implementations an additional bonus system offers employees additional pay for commitment to work assignments on a predefined short term notice (such as being notified less than 1, 8, 12, or 24 hours before the start time of the assignment). The amount of additional pay could be on a sliding scale based upon how many hours in advance the notice was given. For instance, a pay rate of double the usual pay rate could be given to the employee when notice is given less than 8 hours but greater than 1 hour from start time and a pay rate of 1.5 times the usual pay rate could be given to the employee when notice is given less than 24 hours but at least 8 hours from start time. An advance notice more than a certain amount of time, such as 24 hours, would not result in any bonus pay being given to the employee for responding.

An availability review field 270 can be used by the potential employee to review date-time commitments entered into the temporary employment system 100 so that these data-time commitments can be updated or deleted if needed before an potential employer has selected the potential employee for a temporary employment assignment involving one of these date-time commitments. A second qualifications heading 272 indicates a general category of second qualifications that the potential employee can select to be offered for consideration through use of a selection area 274. A licensing review field 276 can be used by the potential employee to update data contained by the employment coordination system 106 concerning license(s) associated with the potential employee.

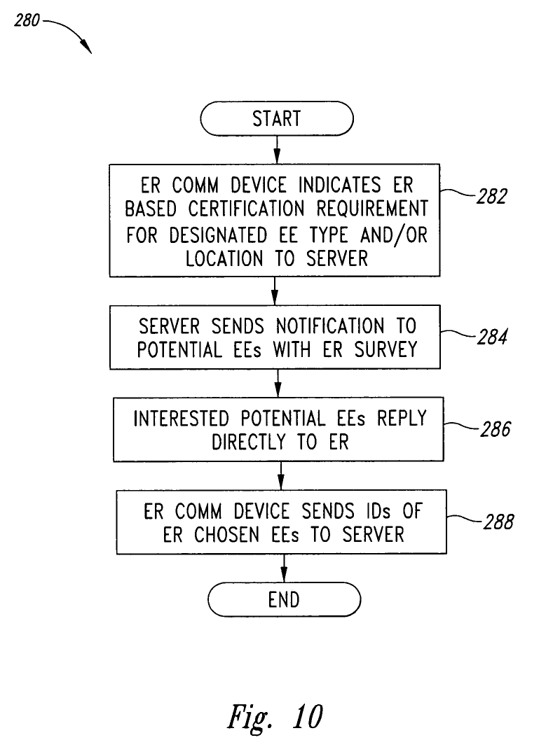

Further implementations furnish capabilities for employers to generate a list of chosen individuals based upon an employer based certification indicating potential employees that the employer will solely consider for so designated temporary assignments. As described in a method 280 shown in FIG. 10, an employer desiring to implement a new employer based certification for a particular employee type and/or location of the temporary assignment will generally first use the ER communication device 102 to send a communication to the server 106 indicating that a particular employee type and/or temporary assignment location requires certification by the employer (step 282). The server 106 will then send (step 284) notification to the EE communication devices 104 of potential employees meeting the general employee type and temporary assignment location criteria associated with the employer based certification. The notification indicates that the notified employees are eligible to apply for the employee based certification and that if certified by the employer, the employee will then be eligible for consideration for specific temporary assignments as they become available. Interested potential employees will then contact (step 286) the employer directly through some sort of address (such as e-mail, postal, phone, or other) such as provided in the notification received by the potential employees to furnish information to the employer per certification instructions originated by the employer. As part of the employer based certification process, the potential employees may be involved with one or more interviews with the employer and/or the employer may conduct background investigation of the potential employees. As directed by the employer, the ER communication device 102 sends identification to the server 106 (step 288) of the potential employees chosen by the employer to be indicated as certified by the employer and the method 280 ends.

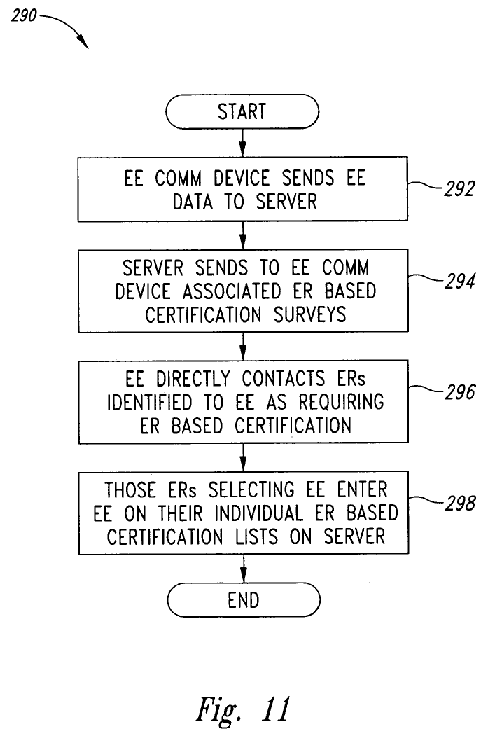

For situations where an employer has already indicated through registration with the server 106 that certain certification by the employer is required, an associated method 290 is shown in FIG. 11 as starting with a newly registering potential employee sending (step 292) data regarding the potential employee (including associated employee type and location availability for temporary assignments) to the server 106 through use of the EE communication device 104. The server 106 then responds (step 294) by sending to the EE communication device of the newly registering potential employee one or more associated employer based certification instructions to be followed for the potential employee to be certified. The certification instructions sent to the newly registering potential employee were originated by employers that had previously indicated to the server those employee types and temporary assignment locations of interest that now match those one or more employee types and temporary assignment locations associated with the newly registering potential employee. The newly registering potential employee, per the received certification instructions, then contacts by e-mail, phone, mail, in person, or other means (step 296) one or more of the employers of interest to the newly registering potential employee to pursue the various certification requirements originated by each of the employers. Those employers that end up certifying the potential employee then enter (step 298) the potential employee identification in their individual certification lists to be subsequently used by the server.

In operation, an employer that has implemented employer based certification can designate an individual temporary assignment as requiring or not requiring a potential employee to have been certified by the employer before the potential employee will be considered for the temporary assignment. If an individual temporary assignment is designated by the employer as requiring employer based certification, then the server 106 will report to the ER communication device 102 of the employer for consideration by the employer for the particular temporary assignment only those potential employees that not only have indicated commitment regarding location and time of the temporary assignment along with the required employee type, but also have been certified by the employer.

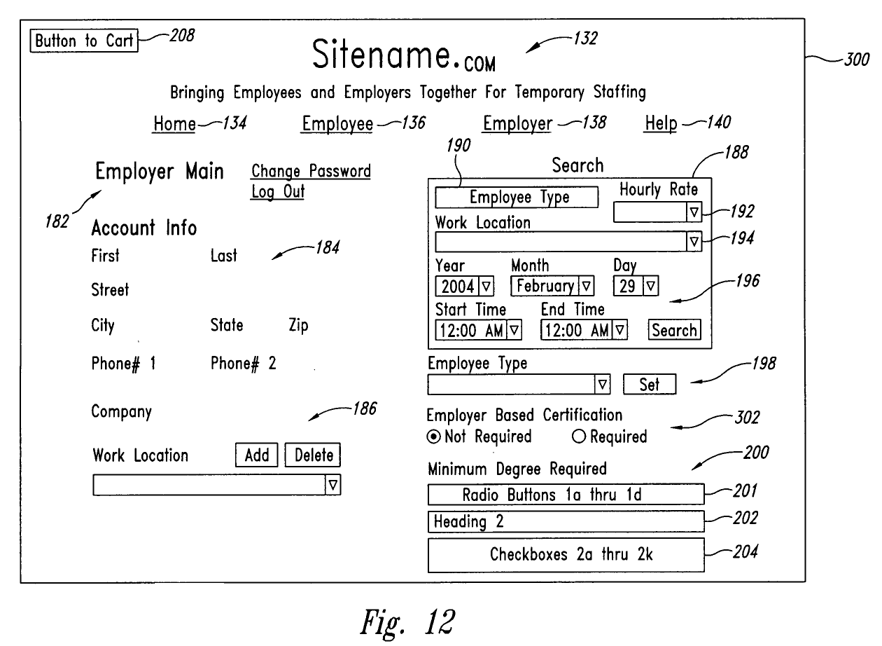

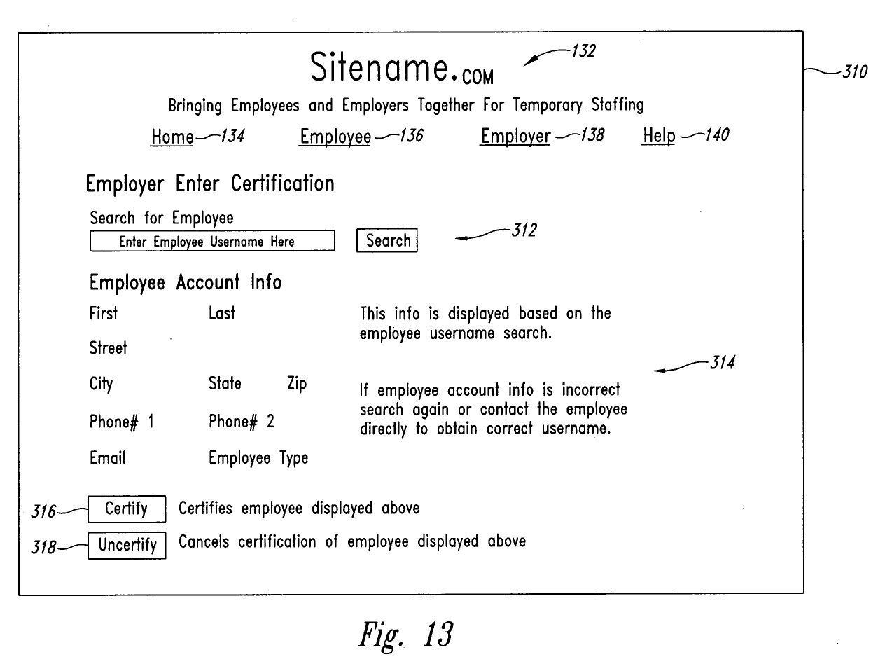

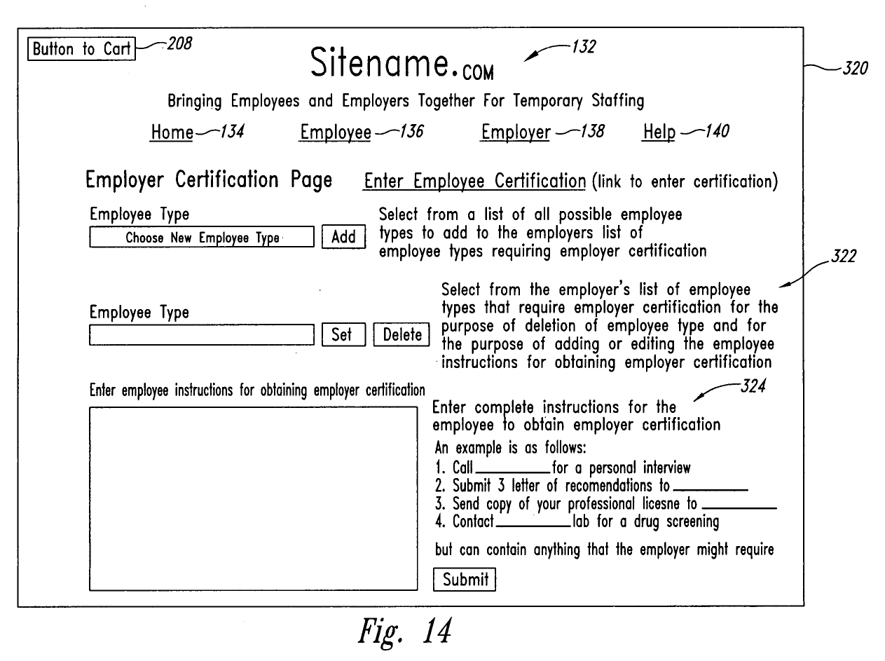

Shown in FIG. 12 is a generically represented employer main page having employer based certification and providing a certification selection option 302 to the employer to require or not require certification by the employer for individual temporary assignments. Shown in FIG. 13 is an implementation of a certification page 310 to be used by employers having an employee selection area 312 to select employees to be either certified or decertified. Once an employee is selected, data on the employee is displayed in an employee data area 314. The employer can then certify the selected employee through use of a certify button 316 or can decertify the selected employee through use of a decertify button 318. Shown in FIG. 14 is a certification initiation page 320 having an employee type area 322 for use by an employer to select an existing employee type or input a new employee type for subsequent association with employer based certification instructions. Once an employee type has been selected or entered, instructions are entered into a certification instructions area 324, which will be subsequently sent to potential employees that have the so related employee type.

From the foregoing it will be appreciated that, although specific embodiments of the invention have been described herein for purposes of illustration, various modifications may be made without deviating from the spirit and scope of the invention. Accordingly, the invention is not limited except as by the appended claims.

1. A system comprising:
an employment coordination server configured to store and retrieve data;
an employee communication device configured to communicate with the employment coordination server to store data on the employment coordination server including potential employee identification, potential employee qualifications associated with the potential employee identification including an employee type, and a wage-time-vicinity commitment associated with the potential employee identification, the wage-time-vicinity commitment containing data indicating a desired wage, a time period of availability, and a geographical area of availability for work to be performed associated with the potential employee qualifications and the potential employee identification; and
an employer communication device configured to communicate with the employment coordination server to transmit data including a potential employer identification and an employment request associated with the potential employer identification, the employment request indicating required qualifications including an employee type, and wage range, time, and place for an assignment, the employment coordination server configured to send notification of a match associated with the potential employee identification and the potential employer identification to the employer communication device if the required qualifications fall within the potential employee qualifications, the desired wage of the wage-time-vicinity commitment falls within the wage range for the assignment, the time of the assignment falls within the time period of availability of the wage-time-vicinity commitment, and the location of the assignment falls within the geographical area of availability for work to be performed of the wage-time-vicinity commitment, the employment coordination server configured to receive an indication of an acceptance of the match associated with the potential employee identification and the potential employer identification from the employer communication device subsequent to transmitting the notification of the match to the employer communication device, the employment coordination server configured to send notification of a binding employment contract associated with the potential employee identification and the potential employer identification to the employee communication device upon the receipt of the indication of the acceptance of the match from the employer communication device.

2. A system comprising:
an employment coordination server configured to to store data including potential employee identification, potential employee qualifications including an employee type associated with the potential employee identification, and a wage-time-vicinity commitment associated with the potential employee identification, the wage-time-vicinity commitment containing data indicating a desired wage, a time period of availability, and a geographical area of availability for work to be performed associated with the potential employee qualifications and the potential employee identification, the employment coordination server configured to store data including a potential employer identification and an employment request associated with the potential employer identification, the employment request indicating required qualifications including an employee type, and wage range, time, and place for an assignment, the employment coordination server configured to send notification of a binding employment contract associated with the potential employee identification and the potential employer identification to a employee communication device if the required qualifications fall within the potential employee qualifications, the desired wage of the wage-time-vicinity commitment falls within the wage range for the assignment, the time of the assignment falls within the time period of availability of the wage-time-vicinity commitment, and the location of the assignment falls within the geographical area of availability for work to be performed of the wage-time-vicinity commitment.

3. A system comprising:
an employment coordination server configured to store and retrieve data;
an employee communication device configured to communicate with the employment coordination server to store data on the employment coordination server including potential employee identification, potential employee qualifications including an employee type associated with the potential employee identification, and a wage-time-vicinity commitment associated with the potential employee identification, the wage-time-vicinity commitment containing data indicating a desired wage, a time period of availability, and a geographical area of availability for work to be performed associated with the potential employee qualifications and the potential employee identification; and
an employer communication device configured to communicate with the employment coordination server to transmit data including a potential employer identification and an employment request associated with the potential employer identification, the employment request indicating required qualifications including an employee type, and wage range, time, and place for an assignment, the employment coordination server configured to send notification of a binding employment contract associated with the potential employee identification and the potential employer identification to the employer communication device if the required qualifications fall within the potential employee qualifications, the desired wage of the wage-time-vicinity commitment falls within the wage range for the assignment, the time of the assignment falls within the time period of availability of the wage-time-vicinity commitment, and the location of the assignment falls within the geographical area of availability for work to be performed of the wage-time-vicinity commitment.

4. A method comprising:
transmitting a potential employee identification;
transmitting potential employee qualifications including an employee type associated with the potential employee identification;
transmitting a wage-time-vicinity commitment associated with the potential employee identification, the wage-time-vicinity commitment containing data indicating a desired wage, a time period of availability, and a geographical area of availability for work to be performed associated with the potential employee qualifications and the potential employee identification;
transmitting a potential employer identification;
transmitting an employment request associated with the potential employer identification, the employment request indicating required qualifications including an employee type, and wage range, time, and place for an assignment;
receiving notification of a match associated with the potential employee identification and the potential employer identification if the required qualifications fall within the potential employee qualifications, the desired wage of the wage-time-vicinity commitment falls within the wage range for the assignment, the time of the assignment falls within the time period of availability of the wage-time-vicinity commitment, and the location of the assignment falls within the geographical area of availability for work to be performed of the wage-time-vicinity commitment;
transmitting an indication of an acceptance of the match associated with the potential employee identification and the potential employer identification subsequent to receiving the notification of the match; and
receiving notification of a binding employment contract associated with the potential employee identification and the potential employer identification upon the transmitting the indication of the acceptance of the match.

5. A method comprising:
storing data including potential employee identification, potential employee qualifications including an employee type associated with the potential employee identification, and a wage-time-vicinity commitment associated with the potential employee identification, the wage-time-vicinity commitment containing data indicating a desired wage, a time period of availability, and a geographical area of availability for work to be performed associated with the potential employee qualifications and the potential employee identification;
storing data including a potential employer identification and an employment request associated with the potential employer identification, the employment request indicating required qualifications including an employee type, and wage range, time, and place for an assignment; and
sending notification of a binding employment contract associated with the potential employee identification and the potential employer identification to a employee communication device if the required qualifications fall within the potential employee qualifications, the desired wage of the wage-time-vicinity commitment falls within the wage range for the assignment, the time of the assignment falls within the time period of availability of the wage-time-vicinity commitment, and the location of the assignment falls within the geographical area of availability for work to be performed of the wage-time-vicinity commitment.

6. A method comprising:
receiving a potential employee identification;
receiving potential employee qualifications associated with the potential employee identification;
receiving a wage-time-vicinity commitment associated with the potential employee identification, the wage-time-vicinity commitment containing data indicating a desired wage, a time period of availability, and a geographical area of availability for work to be performed associated with the potential employee qualifications and the potential employee identification;
receiving a potential employer identification;
receiving an employment request associated with the potential employer identification, the employment request indicating required qualifications, and wage range, time, and place for an assignment;
transmitting notification of a match associated with the potential employee identification and the potential employer identification if the required qualifications fall within the potential employee qualifications, the desired wage of the wage-time-vicinity commitment falls within the wage range for the assignment, the time of the assignment falls within the time period of availability of the wage-time-vicinity commitment, and the location of the assignment falls within the geographical area of availability for work to be performed of the wage-time-vicinity commitment;
receiving an indication of an acceptance of the match associated with the potential employee identification and the potential employer identification subsequent to receiving the notification of the match; and
transmitting notification of an executed employment contract associated with the potential employee identification and the potential employer identification upon the receiving the indication of the acceptance of the match.

7. A-method to allow a potential employer to form a binding employment contract between a potential employee and a potential employer, the method comprising:
transmitting a potential employee entry associated with the potential employee including identification of the potential employee, qualifications of the potential employee including employee type associated with the potential employee identification, and a wage-time-vicinity commitment associated with the potential employee identification, the wage-time-vicinity commitment containing data indicating a desired wage, a time period of availability, and a geographical area of availability for work to be performed associated with the potential employee qualifications and the potential employee identification;
matching the potential employee entry with a temporary employment request of the potential employer; and
presenting the potential employee entry to the potential employer to form the binding employment contract by the potential employer accepting the potential employee entry as an offer to form the employment contract.

8. A method comprising:
transmitting a potential employer identification; and
transmitting an employment request associated with the potential employer identification, the employment request indicating required qualifications, and wage range, time, and place for an assignment; and
searching for a potential employee entry of a potential employee stored in a database to match the employment request and if found, presenting the potential employee entry to a potential employer as an offer to the potential employer to form a binding employment contract between the potential employer and the potential employee.

9. A method comprising:
transmitting notification of a match associated with a potential employee identification and a potential employer identification if required qualifications fall within a potential employee qualifications, a desired wage of a wage-time-vicinity commitment falls within a wage range for an assignment, a time of the assignment falls within a time period of availability of the wage-time-vicinity commitment, and a location of the assignment falls within a geographical area of availability for work to be performed of the wage-time-vicinity commitment; and
receiving an indication of a acceptance of the match and transmitting notification of a binding employment contract associated with the potential employee identification and the potential employer identification upon the receiving of the indication of the acceptance of the match.

10. A method comprising:
storing a potential employee identification;
storing potential employee qualifications associated with the potential employee identification;
storing a wage-time-vicinity commitment associated with the potential employee identification, the wage-time-vicinity commitment containing data indicating a desired wage, a time period of availability, and a geographical area of availability for work to be performed associated with the potential employee qualifications and the potential employee identification;
storing a potential employer identification and an employment request associated with the potential employer identification, the employment request indicating required qualifications, and wage range, time, and place for an assignment; and
transmitting notification of a binding employment contract associated with the potential employee identification and the potential employer identification to the employee communication device if the required qualifications fall within the potential employee qualifications, the desired wage of the wage-time-vicinity commitment falls within the wage range for the assignment, the time of the assignment falls within the time period of availability of the wage-time-vicinity commitment, and the location of the assignment falls within the geographical area of availability for work to be performed of the wage-time-vicinity commitment.

11. A program storage media readable by a computer, the program storage media embodying one or more programs of instructions executable by the computer to perform steps comprising:
transmitting a potential employee identification;
transmitting potential employee qualifications including an employee type associated with the potential employee identification;
transmitting a wage-time-vicinity commitment associated with the potential employee identification, the wage-time-vicinity commitment containing data indicating a desired wage, a time period of availability, and a geographical area of availability for work to be performed associated with the potential employee qualifications and the potential employee identification;
transmitting a potential employer identification;
transmitting an employment request associated with the potential employer identification, the employment request indicating required qualifications including an employee type, and wage range, time, and place for an assignment;
receiving notification of a match associated with the potential employee identification and the potential employer identification if the required qualifications fall within the potential employee qualifications, the desired wage of the wage-time-vicinity commitment falls within the wage range for the assignment, the time of the assignment falls within the time period of availability of the wage-time-vicinity commitment, and the location of the assignment falls within the geographical area of availability for work to be performed of the wage-time-vicinity commitment;
transmitting an indication of an acceptance of the match associated with the potential employee identification and the potential employer identification subsequent to receiving the notification of the match; and
receiving notification of a binding employment contract associated with the potential employee identification and the potential employer identification upon the transmitting the indication of the acceptance of the match.

12. A program storage media readable by a computer, the program storage media embodying one or more programs of instructions executable by the computer to perform steps comprising:
storing data including potential employee identification, potential employee qualifications including an employee type associated with the potential employee identification, and a wage-time-vicinity commitment associated with the potential employee identification, the wage-time-vicinity commitment containing data indicating a desired wage, a time period of availability, and a geographical area of availability for work to be performed associated with the potential employee qualifications and the potential employee identification;
storing data including a potential employer identification and an employment request associated with the potential employer identification, the employment request indicating required qualifications including an employee type, and wage range, time, and place for an assignment; and
sending notification of a binding employment contract associated with the potential employee identification and the potential employer identification to a employee communication device if the required qualifications fall within the potential employee qualifications, the desired wage of the wage-time-vicinity commitment falls within the wage range for the assignment, the time of the assignment falls within the time period of availability of the wage-time-vicinity commitment, and the location of the assignment falls within the geographical area of availability for work to be performed of the wage-time-vicinity commitment.

13. A program storage media readable by a computer, the program storage media embodying one or more programs of instructions executable by the computer to perform steps comprising:
receiving a potential employee identification;
receiving potential employee qualifications associated with the potential employee identification;
receiving a wage-time-vicinity commitment associated with the potential employee identification, the wage-time-vicinity commitment containing data indicating a desired wage, a time period of availability, and a geographical area of availability for work to be performed associated with the potential employee qualifications and the potential employee identification;
receiving a potential employer identification;
receiving an employment request associated with the potential employer identification, the employment request indicating required qualifications, and wage range, time, and place for an assignment;
transmitting notification of a match associated with the potential employee identification and the potential employer identification if the required qualifications fall within the potential employee qualifications, the desired wage of the wage-time-vicinity commitment falls within the wage range for the assignment, the time of the assignment falls within the time period of availability of the wage-time-vicinity commitment, and the location of the assignment falls within the geographical area of availability for work to be performed of the wage-time-vicinity commitment;
receiving an indication of an acceptance of the match associated with the potential employee identification and the potential employer identification subsequent to receiving the notification of the match; and
transmitting notification of an executed employment contract associated with the potential employee identification and the potential employer identification upon the receiving the indication of the acceptance of the match.

14. A program storage media readable by a computer, the program storage media embodying one or more programs of instructions executable by the computer to perform steps to allow a potential employer to form a binding employment contract between a potential employee and a potential employer, the steps comprising:
transmitting a potential employee entry associated with the potential employee including identification of the potential employee, qualifications of the potential employee including employee type associated with the potential employee identification, and a wage-time-vicinity commitment associated with the potential employee identification, the wage-time-vicinity commitment containing data indicating a desired wage, a time period of availability, and a geographical area of availability for work to be performed associated with the potential employee qualifications and the potential employee identification;
matching the potential employee entry with a temporary employment request of the potential employer; and
presenting the potential employee entry to the potential employer to form the binding employment contract by the potential employer accepting the potential employee entry as an offer to form the employment contract.

15. A program storage media readable by a computer, the program storage media embodying one or more programs of instructions executable by the computer to perform steps comprising:
transmitting a potential employer identification; and
transmitting an employment request associated with the potential employer identification, the employment request indicating required qualifications, and wage range, time, and place for an assignment; and
searching for a potential employee entry of a potential employee stored in a database to match the employment request and if found, presenting the potential employee entry to a potential employer as an offer to the potential employer to form a binding employment contract between the potential employer and the potential employee.

16. A program storage media readable by a computer, the program storage media embodying one or more programs of instructions executable by the computer to perform steps comprising:
transmitting notification of a match associated with a potential employee identification and a potential employer identification if required qualifications fall within a potential employee qualifications, a desired wage of a wage-time-vicinity commitment falls within a wage range for an assignment, a time of the assignment falls within a time period of availability of the wage-time-vicinity commitment, and a location of the assignment falls within a geographical area of availability for work to be performed of the wage-time-vicinity commitment; and
receiving an indication of a acceptance of the match and transmitting notification of a binding employment contract associated with the potential employee identification and the potential employer identification upon the receiving of the indication of the acceptance of the match.

17. A program storage media readable by a computer, the program storage media embodying one or more programs of instructions executable by the computer to perform steps comprising:
storing a potential employee identification;
storing potential employee qualifications associated with the potential employee identification;
storing a wage-time-vicinity commitment associated with the potential employee identification, the wage-time-vicinity commitment containing data indicating a desired wage, a time period of availability, and a geographical area of availability for work to be performed associated with the potential employee qualifications and the potential employee identification;
storing a potential employer identification and an employment request associated with the potential employer identification, the employment request indicating required qualifications, and wage range, time, and place for an assignment; and
transmitting notification of a binding employment contract associated with the potential employee identification and the potential employer identification to the employee communication device if the required qualifications fall within the potential employee qualifications, the desired wage of the wage-time-vicinity commitment falls within the wage range for the assignment, the time of the assignment falls within the time period of availability of the wage-time-vicinity commitment, and the location of the assignment falls within the geographical area of availability for work to be performed of the wage-time-vicinity commitment.

18. A system comprising:
means for transmitting a potential employee identification;
means for transmitting potential employee qualifications including an employee type associated with the potential employee identification;
means for transmitting a wage-time-vicinity commitment associated with the potential employee identification, the wage-time-vicinity commitment containing data indicating a desired wage, a time period of availability, and a geographical area of availability for work to be performed associated with the potential employee qualifications and the potential employee identification;
means for transmitting a potential employer identification;
means for transmitting an employment request associated with the potential employer identification, the employment request indicating required qualifications including an employee type, and wage range, time, and place for an assignment;
means for receiving notification of a match associated with the potential employee identification and the potential employer identification if the required qualifications fall within the potential employee qualifications, the desired wage of the wage-time-vicinity commitment falls within the wage range for the assignment, the time of the assignment falls within the time period of availability of the wage-time-vicinity commitment, and the location of the assignment falls within the geographical area of availability for work to be performed of the wage-time-vicinity commitment;
means for transmitting an indication of an acceptance of the match associated with the potential employee identification and the potential employer identification subsequent to receiving the notification of the match; and
means for receiving notification of a binding employment contract associated with the potential employee identification and the potential employer identification upon the transmitting the indication of the acceptance of the match.

19. A system comprising:
means for storing data including potential employee identification, potential employee qualifications including an employee type associated with the potential employee identification, and a wage-time-vicinity commitment associated with the potential employee identification, the wage-time-vicinity commitment containing data indicating a desired wage, a time period of availability, and a geographical area of availability for work to be performed associated with the potential employee qualifications and the potential employee identification;
means for storing data including a potential employer identification and an employment request associated with the potential employer identification, the employment request indicating required qualifications including an employee type, and wage range, time, and place for an assignment; and
means for sending notification of a binding employment contract associated with the potential employee identification and the potential employer identification to a employee communication device if the required qualifications fall within the potential employee qualifications, the desired wage of-the wage-time-vicinity commitment falls within the wage range for the assignment, the time of the assignment falls within the time period of availability of the wage-time-vicinity commitment, and the location of the assignment falls within the geographical area of availability for work to be performed of the wage-time-vicinity commitment.

20. A system comprising:
means for receiving a potential employee identification;
means for receiving potential employee qualifications associated with the potential employee identification;
means for receiving a wage-time-vicinity commitment associated with the potential employee identification, the wage-time-vicinity commitment containing data indicating a desired wage, a time period of availability, and a geographical area of availability for work to be performed associated with the potential employee qualifications and the potential employee identification;
means for receiving a potential employer identification;
means for receiving an employment request associated with the potential employer identification, the employment request indicating required qualifications, and wage range, time, and place for an assignment;
means for transmitting notification of a match associated with the potential employee identification and the potential employer identification if the required qualifications fall within the potential employee qualifications, the desired wage of the wage-time-vicinity commitment falls within the wage range for the assignment, the time of the assignment falls within the time period of availability of the wage-time-vicinity commitment, and the location of the assignment falls within the geographical area of availability for work to be performed of the wage-time-vicinity commitment;
means for receiving an indication of an acceptance of the match associated with the potential employee identification and the potential employer identification subsequent to receiving the notification of the match; and
means for transmitting notification of an executed employment contract associated with the potential employee identification and the potential employer identification upon the receiving the indication of the acceptance of the match.

21. A system to allow a potential employer to form a binding employment contract between a potential employee and a potential employer, the system comprising:
means for transmitting a potential employee entry associated with the potential employee including identification of the potential employee, qualifications of the potential employee including employee type associated with the potential employee identification, and a wage-time-vicinity commitment associated with the potential employee identification, the wage-time-vicinity commitment containing data indicating a desired wage, a time period of availability, and a geographical area of availability for work to be performed associated with the potential employee qualifications and the potential employee identification;
means for matching the potential employee entry with a temporary employment request of the potential employer; and
means for presenting the potential employee entry to the potential employer to form the binding employment contract by the potential employer accepting the potential employee entry as an offer to form the employment contract.

22. A system comprising:
means for transmitting a potential employer identification; and
means for transmitting an employment request associated with the potential employer identification, the employment request indicating required qualifications, and wage range, time, and place for an assignment; and
means for searching for a potential employee entry of a potential employee stored in a database to match the employment request and if found, presenting the potential employee entry to a potential employer as an offer to the potential employer to form a binding employment contract between the potential employer and the potential employee.

23. A system comprising:
means for transmitting notification of a match associated with a potential employee identification and a potential employer identification if required qualifications fall within a potential employee qualifications, a desired wage of a wage-time-vicinity commitment falls within a wage range for an assignment, a time of the assignment falls within a time period of availability of the wage-time-vicinity commitment, and a location of the assignment falls within a geographical area of availability for work to be performed of the wage-time-vicinity commitment; and
means for receiving an indication of a acceptance of the match and transmitting notification of a binding employment contract associated with the potential employee identification and the potential employer identification upon the receiving of the indication of the acceptance of the match.

24. A system comprising:
means for storing a potential employee identification;
means for storing potential employee qualifications associated with the potential employee identification;
means for storing a wage-time-vicinity commitment associated with the potential employee identification, the wage-time-vicinity commitment containing data indicating a desired wage, a time period of availability, and a geographical area of availability for work to be performed associated with the potential employee qualifications and the potential employee identification;
means for storing a potential employer identification and an employment request associated with the potential employer identification, the employment request indicating required qualifications, and wage range, time, and place for an assignment; and
means for transmitting notification of a binding employment contract associated with the potential employee identification and the potential employer identification to the employee communication device if the required qualifications fall within the potential employee qualifications, the desired wage of the wage-time-vicinity commitment falls within the wage range for the assignment, the time of the assignment falls within the time period of availability of the wage-time-vicinity commitment, and the location of the assignment falls within the geographical area of availability for work to be performed of the wage-time-vicinity commitment.
